(19) United States
(12) Patent Application Publication
(10) Pub. No.: US 2023/0350269 A1
(43) Pub. Date: Nov. 2, 2023

(54) FREQUENCY SEPARATOR, OPTICAL QUANTIZATION CIRCUIT, OPTICAL A/D CONVERSION SYSTEM, AND OPTICAL SIGNAL PROCESSING SYSTEM

(71) Applicant: Mitsubishi Electric Corporation, Tokyo (JP)

(72) Inventors: Junya NISHIOKA, Tokyo (JP); Takatoshi AKAMATSU, Tokyo (JP); Naoki SUZUKI, Tokyo (JP); Kiyoshi ONOHARA, Tokyo (JP)

(73) Assignee: Mitsubishi Electric Corporation, Tokyo (JP)

(21) Appl. No.: 18/214,689

(22) Filed: Jun. 27, 2023

Related U.S. Application Data
(63) Continuation of application No. PCT/JP2021/003812, filed on Feb. 3, 2021.

(51) Int. Cl. G02F 7/00; G02F 2/00

(52) U.S. Cl. CPC G02F 2/006; G02F 7/00

(57) ABSTRACT

A frequency separator includes a plurality of filters to separate light having a plurality of optical pulses, each of the optical pulses having one of a plurality of frequencies, into a plurality of light components, each of the light components being to have one of a plurality of frequency bands corresponding to the plurality of frequencies, in which among the plurality of filters, a center frequency of a first frequency band of a first filter and a center frequency of a second frequency band, adjacent to the first frequency band, of a second filter are separated beyond a bandwidth of each of the first and second frequency bands.

### CROSS REFERENCE TO RELATED APPLICATIONS

This application is a Continuation of PCT International Application No. PCT/JP2021/003812 filed on Feb. 03, 2021, which is hereby expressly incorporated by reference into the present application.

### TECHNICAL FIELD

The present disclosure relates to a frequency separator, an optical quantization circuit including the frequency separator, an optical A/D conversion system including the optical quantization circuit, and an optical signal processing system including the optical quantization circuit.

### BACKGROUND ART

In the optical quantization circuit in optical communication disclosed in Patent Literature 1, for example, the accuracy of quantization is improved by use of a red chirp phenomenon and use of a probe optical signal having a narrow frequency distribution in combination. In the optical communication described above, in general, when the width of the optical pulse is narrowed in order to increase the speed, the optical spectrum is broadened.

### CITATION LIST

### Patent Literature

Patent Literature 1: JP 2018-138955 A

### SUMMARY OF INVENTION

### Technical Problem

An object of the present disclosure is to provide a frequency separator, an optical quantization circuit, an optical A/D conversion system, and an optical signal processing system capable of suppressing occurrence of an error in quantization, in view of the fact that, in a case where light is to be separated into a plurality of frequency bands for respective intensities under the broadened optical spectrum described above, a part of energy of a light component to be separated into one frequency band leaks to another frequency band adjacent to the one frequency band, and as a result, an error occurs in the quantization described above regardless of whether or not the above-described use of a red chirp phenomenon and use of a probe optical signal having a narrow frequency distribution are performed in combination.

### Solution to Problem

In order to solve the above problem, a frequency separator according to the present disclosure includes: a plurality of filters to separate light having a plurality of first optical pulses, each of the first optical pulses having one of a plurality of frequencies, into a plurality of light components, each of the light components being to have one of a plurality of frequency bands corresponding to the plurality of frequencies, and to output the light components, in which among the plurality of filters, a center frequency of a first frequency band of a first filter and a center frequency of a second frequency band, adjacent to the first frequency band, of a second filter are separated beyond a bandwidth of each of the first and second frequency bands.

### Advantageous Effects of Invention

According to the frequency separator of the present disclosure, it is possible to suppress occurrence of an error in quantization caused by leakage of energy of a light component to be separated into the one frequency band to another frequency band adjacent to the one frequency band.

### BRIEF DESCRIPTION OF DRAWINGS

FIG. 1 illustrates a configuration of an optical A/D conversion system 10 according to a first embodiment.

FIG. 2 illustrates a configuration of a photoelectric sampling unit 11 of the first embodiment.

FIG. 3 illustrates output characteristics of a void grid frequency separator 13 of the first embodiment.

FIG. 4 illustrates a configuration of an optical multiplexing and distribution circuit 14 of the first embodiment.

FIG. 5 illustrates an operation of the optical A/D conversion system 10 of the first embodiment.

FIG. 6A illustrates an operation of the void grid frequency separator 13 of the first embodiment. FIG. 6B illustrates an operation of a frequency separator of a comparative example. FIG. 6C illustrates an operation of a frequency separator of a second comparative example.

FIG. 7 shows output electric signals SDS(1) to SDS(3) of the first embodiment.

FIG. 8 illustrates a relationship between amplitude of an input electric signal NDS and values indicated by the output electric signals SDS(1) to SDS(3) of the first embodiment.

FIG. 9 illustrates output electric signals SDS(1) to SDS(3) of a first comparative example.

FIG. 10 illustrates a relationship between amplitude of an input electric signal NDS and values indicated by the output electric signals SDS(1) to SDS(3) of the first comparative example.

FIG. 11 illustrates output electric signals SDS(1) to SDS(3) of the second comparative example.

FIG. 12 illustrates a relationship between amplitude of an input electric signal NDS and values indicated by the output electric signals SDS(1) to SDS(3) of the second comparative example.

FIG. 13 illustrates a configuration of an optical A/D conversion system 20 of a second embodiment.

FIG. 14 illustrates a configuration of a gray-code optical multiplexing and distribution circuit 24 according to the second embodiment.

FIG. 15 illustrates an operation of the optical A/D conversion system 20 of the second embodiment.

FIG. 16 illustrates output electric signals SDS(1) to SDS(3) of the second embodiment.

FIG. 17 illustrates a relationship between the amplitude of an input electric signal NDS and a value indicated by a final output electric signal SSDS of the second embodiment.

FIG. 18 illustrates a relationship between amplitude of an input electric signal NDS and a value indicated by a final output electric signal SSDS of the comparative example.

### DESCRIPTION OF EMBODIMENTS

An embodiment of an optical A/D conversion system according to the present disclosure will be described.

### First Embodiment

### Configuration of First Embodiment

### Overall Configuration

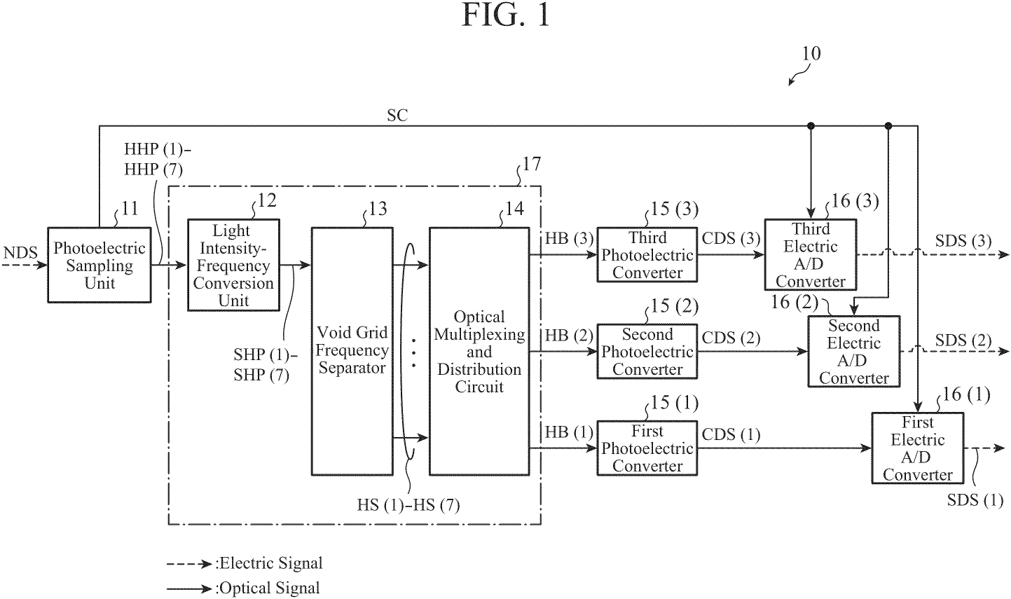

FIG. 1 illustrates a configuration of an optical A/D conversion system 10 according to a first embodiment. Hereinafter, the configuration of the optical A/D conversion system 10 of the first embodiment will be described with reference to FIG. 1.

In order to convert an input electric signal NDS that is an analog value into first to third output electric signals SDS(1) to SDS(3) that are digital values, that is, in order to perform A/D conversion, the optical A/D conversion system 10 of the first embodiment includes, as illustrated in FIG. 1, a photoelectric sampling unit 11, a light intensity-frequency conversion unit 12, a void grid frequency separator 13, an optical multiplexing and distribution circuit 14, first to third photoelectric converters 15(1) to 15(3), and first to third electric A/D converters 16(1) to 16(3).

The light intensity-frequency conversion unit 12, the void grid frequency separator 13, and the optical multiplexing and distribution circuit 14 constitute an optical quantization circuit 17.

The void grid frequency separator 13 corresponds to a “frequency separator”.

The optical quantization circuit 17 corresponds to an “optical quantization circuit”. The light intensity-frequency conversion unit 12 corresponds to a “first conversion unit”. The optical multiplexing and distribution circuit 14 corresponds to a “second conversion unit”.

The photoelectric sampling unit 11 corresponds to a “generation unit”. The first to third photoelectric converters 15(1) to 15(3) correspond to “photoelectric conversion units”. The first to third electric A/D converters 16(1) to 16(3) correspond to “A/D conversion units”.

The photoelectric sampling unit 11 converts the input electric signal NDS into a plurality of light intensity optical pulses HHP(1) to HHP(7). Specifically, the photoelectric sampling unit 11 samples, that is, periodically extracts the input electric signal NDS to convert the input electric signal NDS into light intensity optical pulses HHP(1) to HHP(7), which are optical pulses each having light intensity corresponding to the voltage, that is, the magnitude of amplitude of the input electric signal NDS.

The light intensity-frequency conversion unit 12 converts the light intensity optical pulses HHP(1) 1 to HHP(7) into frequency optical pulses SHP(1) to SHP(7). Specifically, the light intensity-frequency conversion unit 12 converts the light intensity optical pulses HHP(1) to HHP(7) into frequency optical pulses SHP(1) to SHP(7) which are optical pulses having frequencies corresponding to the light intensities of the light intensity optical pulses HHP(1) to HHP(7).

The void grid frequency separator 13 separates the frequency optical pulses SHP(1) to SHP(7) into a plurality of light components HS(1) to HS(7). Specifically, the void grid frequency separator 13 separates the frequency optical pulses SHP(1) to SHP(7) into the light components HS(1) to HS(7) that should have frequency bands ΔF(1) to ΔF(7) (shown in FIG. 3.) corresponding to frequencies F(1) to F(7) (shown in FIG. 3.) of the frequency optical pulses SHP(1) to SHP(7).

The optical multiplexing and distribution circuit 14 generates a first optical bit HB(1), a second optical bit HB(2), and a third optical bit HB(3) by integrating or dividing the light components HS(1) to HS(7).

The first to third photoelectric converters 15(1) to 15(3) convert the first to third optical bits HB(1) to HB(3) into first to third intermediate electric signals CDS(1) to CDS(3) which are analog values. Specifically, the first photoelectric converter 15(1) converts the first optical bit HB(1) into the first intermediate electric signal CDS(1). The second photoelectric converter 15(2) converts the second optical bit HB(2) into the second intermediate electric signal CDS(2). The third photoelectric converter 15(3) converts the third optical bit HB(3) into the third intermediate electric signal CDS(3).

The first to third electric A/D converters 16(1) to 16(3) convert the first to third intermediate electric signals CDS(1) to CDS(3) which are analog values into first to third output electric signals SDS(1) to SDS(3) which are digital values. Specifically, the first electric A/D converter 16(1) converts the first intermediate electric signal CDS(1) into the first output electric signal SDS(1). The second electric A/D converter 16(2) converts the second intermediate electric signal CDS(2) into the second output electric signal SDS(2). The third electric A/D converter 16(3) converts the third intermediate electric signal CDS(3) into the third output electric signal SDS(3).

Regarding the relationship between the number of light components HS(1) to HS(7) input to the optical multiplexing and distribution circuit 14 and the number of optical bits HB(1) to HB(3) output from the optical multiplexing and distribution circuit 14, the former number is mostly larger than the latter number. For example, the former number is (2 to the power of M -1), while the latter number is M, e.g., the former number is 7 and the latter number is 3.

### Configuration of Photoelectric Sampling Unit 11

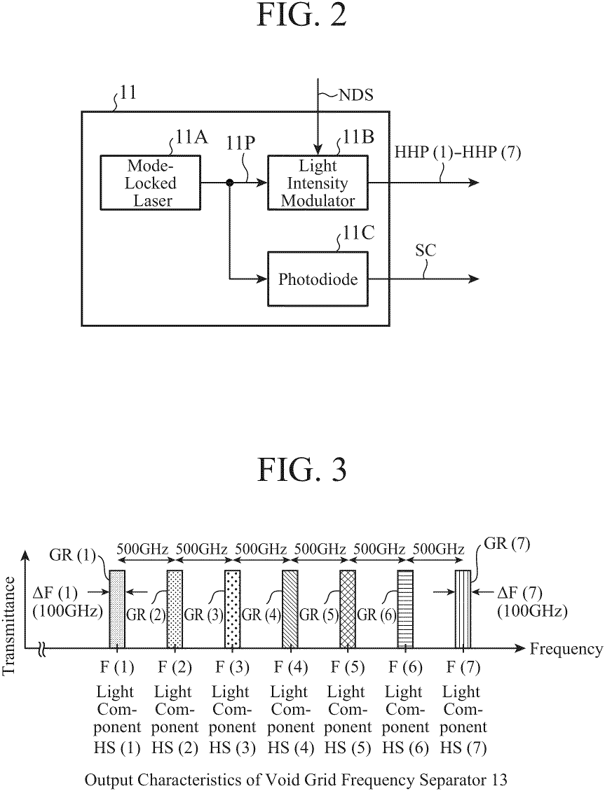

FIG. 2 illustrates a configuration of the photoelectric sampling unit 11 of the first embodiment.

As illustrated in FIG. 2, the photoelectric sampling unit 11 includes a mode-locked laser 11A, a light intensity modulator 11B, and a photodiode 11C.

The mode-locked laser 11A generates an optical pulse 11P and periodically outputs the optical pulse 11P to the light intensity modulator 11B and the photodiode 11C. The light intensity modulator 11B modulates the intensity of the optical pulse 11P depending on the magnitude of the amplitude of the input electric signal NDS, thereby generating light intensity optical pulses HHP(1) to HHP(7).

The photodiode 11C converts the optical pulse 11P into a sampling clock SC having the same frequency as the pulse repetition frequency of the optical pulse 11P and being an electric signal.

The mode-locked laser 11A may be, for example, an optical frequency comb generated by an electro-optical modulator. The light intensity modulator 11B only needs to be able to modulate the light intensity of the optical pulse 11P depending on the magnitude of the amplitude of the input electric signal NDS, and may be, for example, a light intensity modulator that performs intensity modulation by a Mach-Zehnder interferometer or an electro-absorption type light intensity modulator that performs intensity modulation by an electro-absorption effect.

### Configuration of Light Intensity-Frequency Conversion Unit 12

Returning to FIG. 1, the light intensity-frequency conversion unit 12 shifts the frequency for each light intensity, that is, converts the frequency into a frequency corresponding to the light intensity, and performs the conversion by using, for example, a soliton self frequency shift phenomenon (SSFS) due to a non-linear optical effect. In order to efficiently generate the soliton self frequency shift phenomenon, for example, a highly nonlinear fiber or a photonic crystal is preferably used.

In addition to the soliton self frequency shift phenomenon, for example, the light intensity-frequency conversion unit 12 may generate a frequency chirp phenomenon of a rise of an optical pulse that changes depending on the light intensity of the optical pulse using an optical semiconductor amplifier, or may use a frequency chirp phenomenon that occurs when the optical pulse is optically amplified.

### Configuration of Void Grid Frequency Separator 13

FIG. 3 illustrates output characteristics of the void grid frequency separator 13 of the first embodiment.

In order to output the seven light components HS(1) to HS(7), the void grid frequency separator 13 has grids GR(1) to GR(7) in the number corresponding to the number of frequencies extracted by the void grid frequency separator 13, that is, seven, as shown in FIG. 3. The grids GR(1) to GR(7) each have substantially the function of a band filter. The width (-3 dB), that is, the bandwidth, of each of the grids GR(1) to GR(7) is 100 GHz, and the interval between the grids GR(1) to GR(7) is 500 GHz.

Here, the grid interval is a distance between center frequencies (For example, the frequency F(1) and the frequency F(2)) of two respective frequency bands (For example, a frequency band ΔF(1) and a frequency band ΔF(2)) adjacent to each other among the frequency bands ΔF(1) to ΔF(7). The grid interval only have to be wider than the bandwidth of the grid, in other words, adjacent center frequencies (For example, F(1) and F(2)) only have to be separated from each other by exceeding the bandwidth (100 GHz) of the frequency band (ΔF(1), ΔF(2)). The grid interval may be wider or narrower than above-described 500 GHz as long as the above-described conditions for the relationship with the bandwidth are satisfied.

Among the center frequencies F(1) to F(7), the center frequency F(1) is the lowest frequency, and in contrast, the center frequency F(7) is the highest frequency. The bandwidths of the frequency bands ΔF(1) to ΔF(7) are identical (For example, 100 GHz) to each other regardless of the high and low of the center frequencies F(1) to F(7).

The number of grids may be larger or smaller than 7. The width of each of the grids GR(1) to GR(7) may be wider or narrower than 100 GHz.

The void grid frequency separator 13 may be, for example, an arrayed waveguide grating (AWG), a wavelength division multiplexing (WDM) coupler, or a wavelength selective switch (WSS), and may be integrated using a planar lightwave circuit (PLC) or silicon.

### Configuration of Optical Multiplexing and Distribution Circuit 14

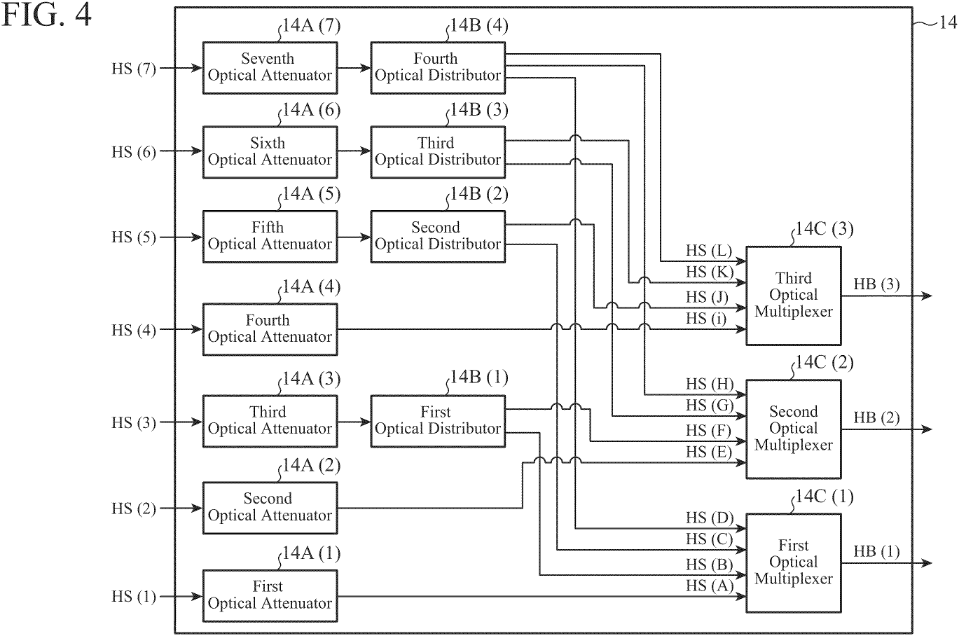

FIG. 4 illustrates a configuration of the optical multiplexing and distribution circuit 14 of the first embodiment.

As illustrated in FIG. 4, the optical multiplexing and distribution circuit 14 includes seven first to seventh optical attenuators 14A(1) to 14A(7), four first to fourth optical distributors 14B(1) to 14B(4), and three first to third optical multiplexers 14C(1) to 14C(3).

The first to seventh optical attenuators 14A(1) to 14A(7) adjust the light intensities of the light components HS(1) to HS(7) output from the void grid frequency separator 13, more specifically attenuate the light intensities.

As an example, the first to fourth optical distributors 14B(1) to 14B(4) distribute the light components HS(3), HS(5), HS(6), and HS(7) among the attenuated light components HS(1) to HS(7) output from the first to seventh optical attenuators 14A(1) to 14A(7).

The light components HS(3), HS(5), HS(6), and HS(7) described above are distributed and supplied, and the light components HS(1), HS(2), and HS(4) which are the other light components are supplied without being distributed. Accordingly, as illustrated in FIG. 4, light components HS(A) to HS(D) are input to the first optical multiplexer 14C(1), light components HS(E) to HS(H) are input to the second optical multiplexer 14C(2), and light components HS(i) to HS(L) are input to the third optical multiplexer 14C(3).

The first optical multiplexer 14C(1) multiplexes the light components HS(A) to HS(D) to generate the first optical bit HB(1). The second optical multiplexer 14C(2) multiplexes the light components HS(E) to HS(H) to generate the second optical bit HB(2). The third optical multiplexer 14C(3) multiplexes the light components HS(i) to HS(L) to generate the third optical bit HB(3).

Here, the third HB(3) is MSB (Most Significant Bit), and the first HB(1) is LSB (Least Significant Bit).

The optical multiplexing and distribution circuit 14 may be integrated using a planar lightwave circuit (PLC) or silicon, or may be not integrated, that is, may be a barrack. It may be configured using a WDM coupler or a wavelength selection switch.

### Configurations of First to Third Photoelectric Converters 15(1) to 15(3)

Returning to FIG. 1, the first to third photoelectric converters 15(1) to 15(3) are configured using, for example, a photodiode, or a photodiode and a transimpedance amplifier.

### Configurations of First to Third Electric A/D Converters 16(1) to 16(3)

The first to third electric A/D converters 16(1) to 16(3) may have a resolution of a plurality of bits, or may have a resolution of 1 bit, and may be, for example, comparators.

### Operation of First Embodiment

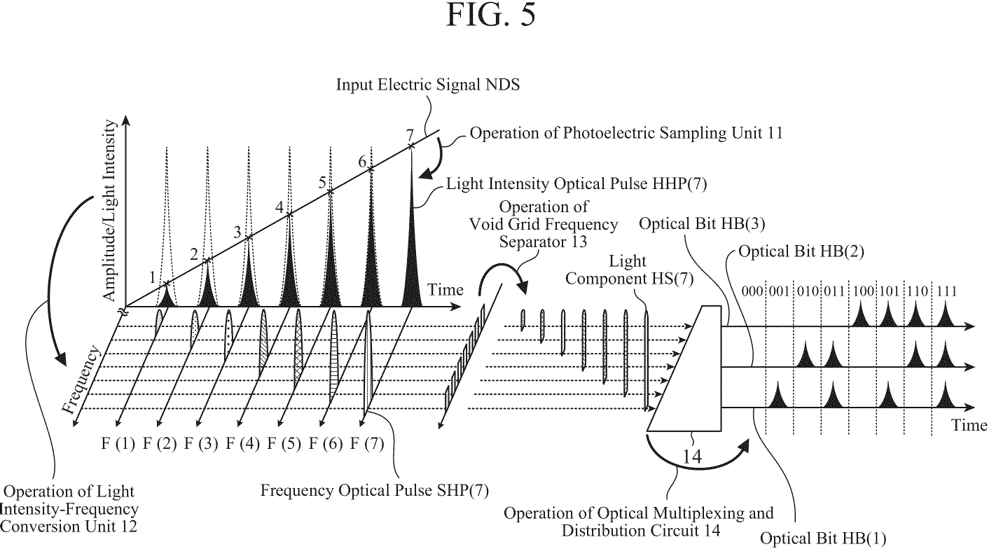

FIG. 5 illustrates an operation of an optical A/D conversion system 10 of the first embodiment.

The operation of the optical A/D conversion system 10 of the first embodiment will be described with reference to FIG. 5.

In FIG. 2, in the photoelectric sampling unit 11, when the optical pulse 11P is output from the mode-locked laser 11A, the light intensity modulator 11B modulates the optical pulse 11P on the basis of the input electric signal NDS. As a result, as illustrated in FIG. 5, the light intensity optical pulses HHP(1) to HHP(7) (Only HHP(7) is shown.) having light intensity corresponding to the magnitude of the amplitude of the input electric signal NDS are generated.

Here, as illustrated in FIG. 5, the amplitude of the voltage of the input electric signal NDS is temporally linear, the relationship between the input electric signal NDS and the light intensity optical pulses HHP(1) to HHP(7) in the light intensity modulator 11B is linear, and thus the light intensity of the light intensity optical pulses HHP(1) to HHP(7) is also temporally linear.

In the following, for ease of description and understanding, it is assumed that the amplitude of the input electric signal NDS is seven discrete values of 1, 2, 3, 4, 5, 6, and 7 as illustrated in FIG. 5.

When the light intensity optical pulses HHP(1) to HHP(7) are supplied, the light intensity-frequency conversion unit 12 generates a soliton self frequency shift phenomenon (SSFS). As a result, frequency optical pulses SHP(1) to SHP(7) (Only SHP(7) is shown.) having frequencies F(1) to F(7) different for light intensities of the respective light intensity optical pulses HHP(1) to HHP(7) are generated.

Here, as illustrated in FIG. 5, the discrete amplitude values 1 to 7 of the input electric signal NDS correspond to the center frequencies F(1) to F(7). For example, when the amplitude value of the input electric signal NDS is 1, the center frequency is F(1), and only the frequency optical pulse SHP(1) of the center frequency F(1) is generated, that is, “present”, while other frequency optical pulses SHP(2) to SHP(7) are not generated, that is, “absent”. Similarly, when the amplitude value of the input electric signal NDS is 2, the center frequency is F(2), and when the amplitude value of the input electric signal NDS is 7, the center frequency is F(7).

The void grid frequency separator 13 separates the frequency optical pulses SHP(1) to SHP(7) using the grids GR(1) to GR(7) illustrated in FIG. 3. The void grid frequency separator 13 more particularly separates using the grids GR(1) to GR(7) shown in FIG. 3, whose center frequencies are F(1) to F(7), whose bandwidths ΔF(1) to ΔF(7) are 100 GHz, and whose interval between adjacent grids is 500 GHz.

As an example, the optical multiplexing and distribution circuit 14 has an input/output characteristics satisfying the following equation (1).

$$\left(\begin{matrix}{E}_{P D 3} \\ {E}_{P D 2} \\ {E}_{P D 3}\end{matrix}\right) = \left(\begin{matrix}1 & 0 & 1 & 0 & 1 & 0 & 1 \\ 0 & 1 & 1 & 0 & 0 & 1 & 1 \\ 0 & 0 & 0 & 1 & 1 & 1 & 1\end{matrix}\right) \left(\begin{matrix}\sqrt{1 / 1} & & 0 \\ & ⋱ & \\ 0 & & \sqrt{1 / 7}\end{matrix}\right) \left(\begin{matrix}{E}_{D W D M 1} \\ {E}_{D W D M 2} \\ {E}_{D W D M 3} \\ {E}_{D W D M 4} \\ {E}_{D W D M 5} \\ {E}_{D W D M 6} \\ {E}_{D W D M 7}\end{matrix}\right) \qquad \text{(1)}$$

Assuming s is an integer of 1 to 7 and t is an integer of 1 to 3, E_DWDMs is a photoelectric field of the s-th light component HS(s) and E_PDt is the photoelectric field of the t-th optical bit HB(t).

Here, it is assumed that the light intensity optical pulses HHP(1) to HHP(7) input to the light intensity-frequency conversion unit 12 and the frequency optical pulses SHP(1) to SHP(7) output from the light intensity-frequency conversion unit 12 have a proportional relationship. Under the above assumption, because the light components HS(1) to HS(7) have equal electric fields and equal amplitudes, the rising edges of the optical bits HB(1) to HB(3) are synchronized with each other.

In contrast to the above, in a case where the light intensity optical pulses HHP(1) to HHP(7) and the frequency optical pulses SHP(1) to SHP(7) are not in a proportional relationship or in a case where the spectra of the frequency optical pulses SHP(1) to SHP(7) are spread, the above synchronization is ensured by adjusting the loss value represented by the square root in the above equation (1) depending on the degree not in the proportional relationship or the degree of spread of the spectra.

As illustrated in FIG. 1, the optical bits HB(1) to HB(3) pass through the first to third photoelectric converters 15(1) to 15(3) and the first to third electric A/D converters 16(1) to 16(3), and are converted into the output electric signals SDS(1) to SDS(3), that is, quantized.

By the operation of the optical A/D conversion system 10 of the first embodiment described above, for example, the input electric signal NDS having an analog value with an amplitude value of 1 is converted into the third optical bit HB(3) which is 0, the second optical bit HB(2) which is 0, and the first optical bit HB(1) which is 1, and after the conversion, the third output electric signal SDS(3) which is 0, the second output electric signal SDS(2) which is 0, and the first output electric signal SDS(1) which is 1 are output as digital values.

In addition, the input electric signal NDS having an amplitude value of 2 is converted into the third optical bit HB(3) which is 0, the second optical bit HB(2) which is 1, and the first optical bit HB(1) which is 0, and after the conversion, the third output electric signal SDS(3) which is 0, the second output electric signal SDS(2) which is 1, and the first output electric signal SDS(1) which is 0 are output as digital values.

Similarly, the input electric signal NDS having an amplitude value of 7 is converted into the third optical bit HB(3) which is 1, the second optical bit HB(2) which is 1, and the first optical bit HB(1) which is 1, and after the conversion, the third output electric signal SDS(3) which is 1, the second output electric signal SDS(2) which is 1, and the first output electric signal SDS(1) which is 1 are output as digital values. In summary, the first to third optical bits HB(1) to HB(3) and the first to third output electric signals SDS(1) to SDS(3) are converted to larger values as the amplitude of the input electric signal NDS is larger, in other words, as the light intensity of the light intensity optical pulses HHP(1) to HHP(7) is larger.

### Effects of First Embodiment

As described above, in the void grid frequency separator 13 of the first embodiment, as shown in FIG. 3, in order to separate the light components HS(1) to HS(7), adjacent center frequencies among the center frequencies F(1) to F(7) are separated from each other by a distance (For example, 500 GHz) exceeding the bandwidth (For example, 100 GHz) of the frequency bands ΔF(1) to ΔF(7). As a result, in the optical A/D conversion system 10 of the first embodiment, it is possible to suppress occurrence of an error in quantization caused by leakage of optical energy in one frequency band to another frequency band adjacent to the one frequency band.

In the optical quantization circuit 17 (it is shown in FIG. 1.) of the first embodiment, before the optical multiplexing and distribution circuit 14 integrates or divides the light components HS(1) to HS(7), leakage of the light components HS(1) to HS(7) between adjacent grids is suppressed by the void grid frequency separator 13. Thereby, in the optical quantization circuit 17, the optical multiplexing and distribution circuit 14 can generate the optical bits HB(1) to HB(3) with higher accuracy than a case where the suppression is not performed.

The void grid frequency separator 13 of the first embodiment also compresses the light intensity optical pulses HHP(1) to HHP(7) into the bandwidth (For example, 100 GHz) of the grids GR(1) to GR(7). This eliminates the need for a low-gain spectral compressor. This can reduce the number of gain compensation components, and as a result, the cost can be reduced.

Further, the void grid frequency separator 13 of the first embodiment does not need to have its bandwidth corresponding to the spectral width of the light intensity optical pulses HHP(1) to HHP(7). As a result, it is possible to perform design using a general-purpose product, in other words, it is possible to facilitate the design and to reduce the cost.

### First Embodiment and Comparative Examples

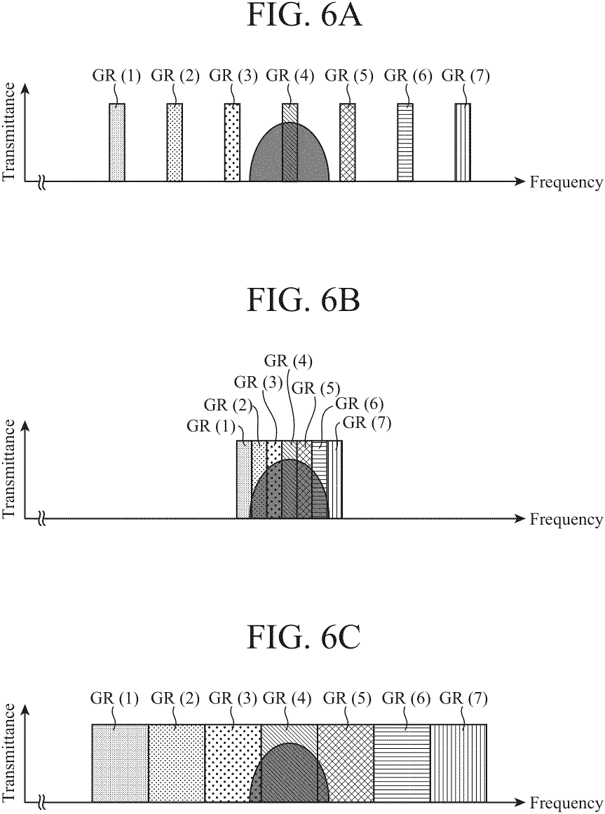

FIG. 6 illustrates an operation of the void grid frequency separator 13 of the first embodiment and an operation of a frequency separator of each of the comparative examples.

In the void grid frequency separator 13 of the first embodiment, as shown in FIG. 6A, the grids GR(1) to GR(7) are not in contact with each other, that is, there is a void between the grids GR(1) to GR(7).

In contrast to the above, in the frequency separator of each of the comparative examples, as illustrated in FIGS. 6B and 6C, the grids GR(1) to GR(7) are in contact with each other, that is, there is no void between the grids GR(1) to GR(7). Specifically, in a frequency separator of a first comparative example, as illustrated in FIG. 6B, the widths of the grids GR(1) to GR(7) are the same as the grid width (For example, 100 GHz) of the void grid frequency separator 13, and there is no void between the grids GR(1) to GR(7). In addition, in a frequency separator of a second comparative example, as illustrated in FIG. 6C, the widths of the grids GR(1) to GR(7) are the same as the interval (For example, 500 GHz) between the grids of the void grid frequency separator 13, and there is no void between the grids.

In the void grid frequency separator 13 of the first embodiment, as shown in FIG. 6A, for example, even when the light component HS(4) of the center frequency F(4) passing through the grid GR(4) spreads on the frequency axis, the presence of a void between the grids described above prevents the energy of the light component HS(4) from leaking to the grids GR(3) and GR(5) adjacent to the grid GR(4).

In the frequency separator of the first comparative example, as illustrated in FIG. 6B, the energy of the light component HS(4) flows into the other grids GR(1), GR(2), GR(3), GR(5), GR(6), and GR(7) due to the absence of the above-described void, and thus, an error occurs in quantization.

In the frequency separator of the second comparative example, as illustrated in FIG. 6C, the energy of the light component HS(4) flows into the other grids GR(3) and GR(5) adjacent to the GR(4) due to the absence of the above-described void, and thus, an error occurs in quantization.

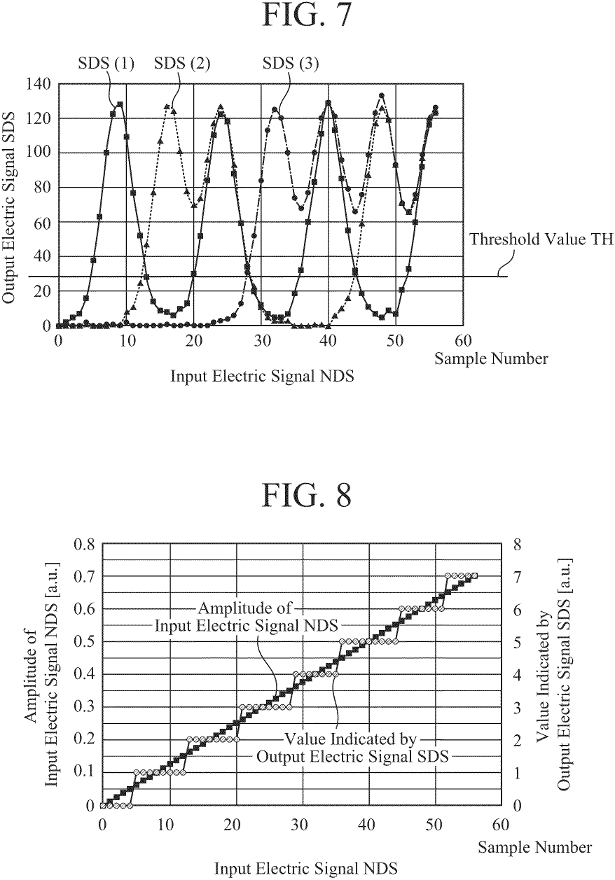

FIG. 7 shows the output electric signals SDS(1) to SDS(3) of the first embodiment.

In FIG. 7, the horizontal axis represents the sample number of the input electric signal NDS. Specifically, the horizontal axis indicates 57 sample numbers of the input electric signal NDS in which the amplitude of the input electric signal NDS is linearly swept in increments of 0.1 from 0 to 7. The vertical axis represents the sizes of the output electric signals SDS(1) to SDS(3) quantized in 8 bits (255 ways).

When the output electric signals SDS(1) to SDS(3) are larger than a threshold value TH, those are determined as 1, and on the other hand, when the output electric signals SDS(1) to SDS(3) are smaller than the threshold value TH, those are determined as 0.

FIG. 8 illustrates a relationship between the amplitude of the input electric signal NDS and values indicated by the output electric signals SDS(1) to SDS(3) of the first embodiment.

As illustrated in FIG. 8, the optical A/D conversion system 10 of the first embodiment A/D-converts the input electric signal NDS that is an analog value into the output electric signals SDS(1) to SDS(3) that are digital values, and more specifically, for example, converts the linearly changing input electric signal NDS into the output electric signals SDS(1) to SDS(3) without error.

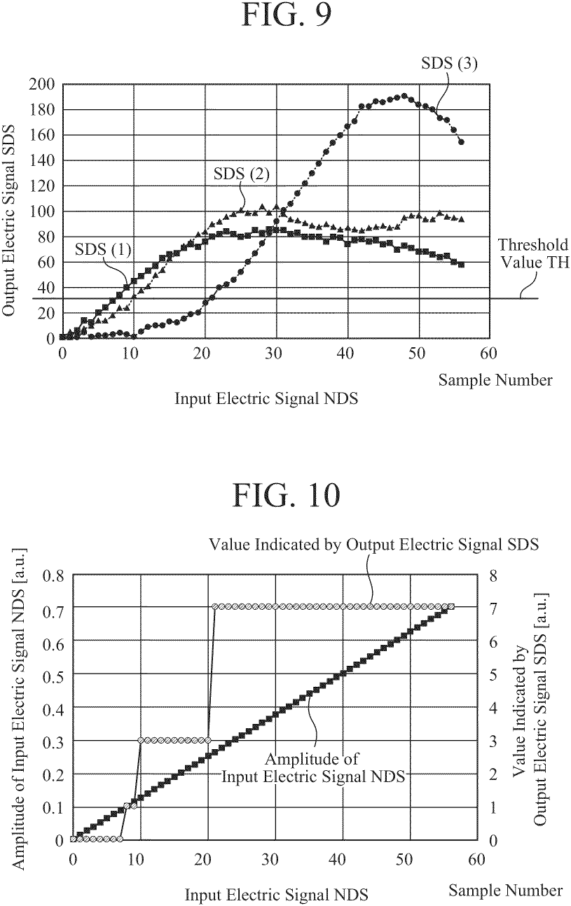

FIG. 9 shows the output electric signals SDS(1) to SDS(3) of the first comparative example.

FIG. 10 shows the relationship between the amplitude of the input electric signal NDS and the values indicated by the output electric signals SDS(1) to SDS(3) of the first comparative example.

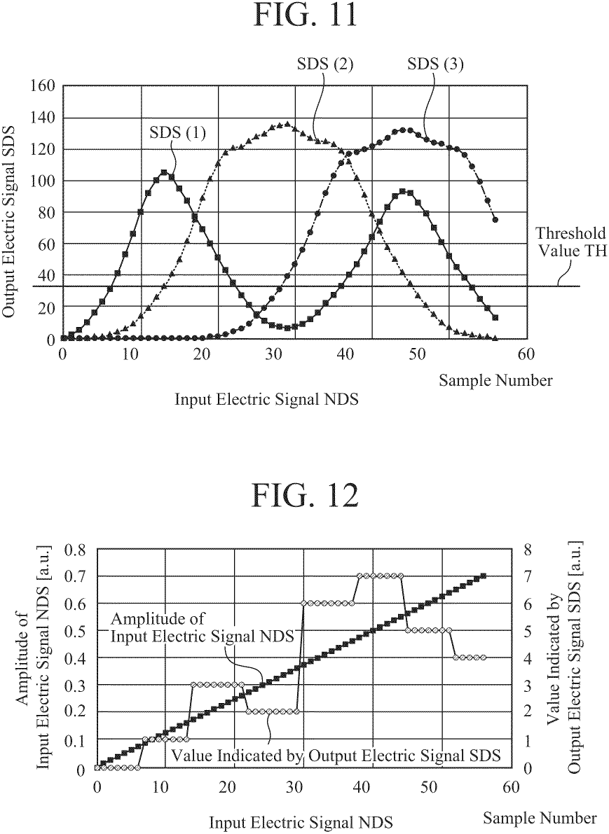

FIG. 11 shows the output electric signals SDS(1) to SDS(3) of the second comparative example.

FIG. 12 shows the relationship between the amplitude of the input electric signal NDS and the values indicated by the output electric signals SDS(1) to SDS(3) of the second comparative example.

In the first embodiment, as illustrated in FIG. 8, quantization is performed within an error of 1.

When FIG. 7 is compared with FIGS. 9 and 11, the output electric signals SDS(1) to SDS(3) (FIG. 9 and FIG. 11 illustrate the same.) of the first comparative example and the second comparative example are extremely different from the output electric signals SDS(1) to SDS(3) (FIG. 7 illustrates the same.) of the first embodiment. Due to this difference, in the first comparative example and the second comparative example, quantization is performed within a range larger than the error of 1 as illustrated in FIGS. 10 and 12.

Therefore, the quantization according to the first embodiment is superior to the quantization according to the first comparative example and the quantization according to the second comparative example.

### Modifications

Instead of the above-described quantization with 8 bits, the first to third electric A/D converters 16(1) to 16(3) may perform quantization with other bit numbers, and for example, a comparator that performs quantization with 1 bit may be used.

The input electric signal NDS may variously change with time instead of linearly changing with time as described above.

### Second Embodiment

### Configuration of Second Embodiment

### Overall Configuration

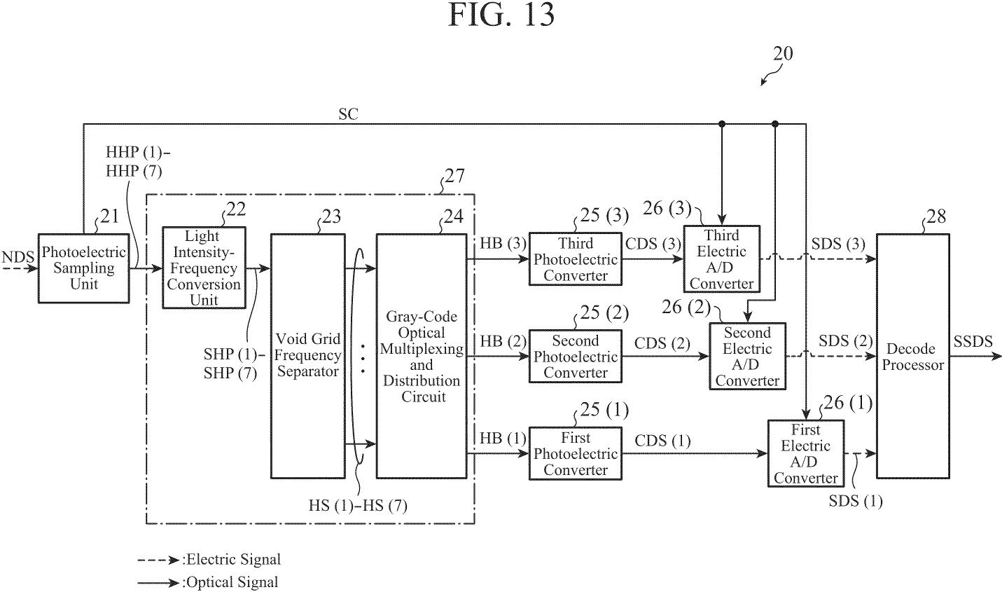

FIG. 13 illustrates a configuration of an optical A/D conversion system 20 according to a second embodiment. Hereinafter, the configuration of the optical A/D conversion system 20 of the second embodiment will be described with reference to FIG. 13.

As illustrated in FIG. 13, in order to perform A/D conversion of an input electric signal NDS that is an analog value into a final output electric signal SSDS that is a digital value, the optical A/D conversion system 20 of the second embodiment includes a photoelectric sampling unit 21, a light intensity-frequency conversion unit 22, a void grid frequency separator 23, first to third photoelectric converters 25(1) to 25(3), and first to third electric A/D converters 26(1) to 26(3), similarly to the optical A/D conversion system 10 of the first embodiment (FIG. 1 illustrates the same.).

The functions of the photoelectric sampling unit 21, the light intensity-frequency conversion unit 22, the void grid frequency separator 23, the first to third photoelectric converters 25(1) to 25(3), and the first to third electric A/D converters 26(1) to 26(3) of the second embodiment are the same as the functions of the photoelectric sampling unit 11, the light intensity-frequency conversion unit 12, the void grid frequency separator 13, the first to third photoelectric converters 15(1) to 15(3), and the first to third electric A/D converters 16(1) to 16(3) of the first embodiment.

On the other hand, the optical A/D conversion system 20 of the second embodiment does not have the function of the optical multiplexing and distribution circuit 14 unlike the optical A/D conversion system 10 of the first embodiment, and includes a gray-code optical multiplexing and distribution circuit 24 and a decode processor 28.

The light intensity-frequency conversion unit 22, the void grid frequency separator 23, and the gray-code optical multiplexing and distribution circuit 24 constitute a quantization circuit 27.

The gray-code optical multiplexing and distribution circuit 24 corresponds to a “second conversion unit”. The decode processor 28 corresponds to a “decode unit”.

The gray-code optical multiplexing and distribution circuit 24 multiplexes and distributes the light components HS(1) to HS(7) output from the void grid frequency separator 23 to the optical bits HB(1) to HB(3) constituting the gray code.

The decode processor 28 decodes the output electric signals SDS(1) to SDS(3) which are digital values and output from the first to third electric A/D converters 26(1) to 26(3) into a final output electric signal SSDS which is a digital value.

### Configuration of Gray-Code Optical Multiplexing and Distribution Circuit 24

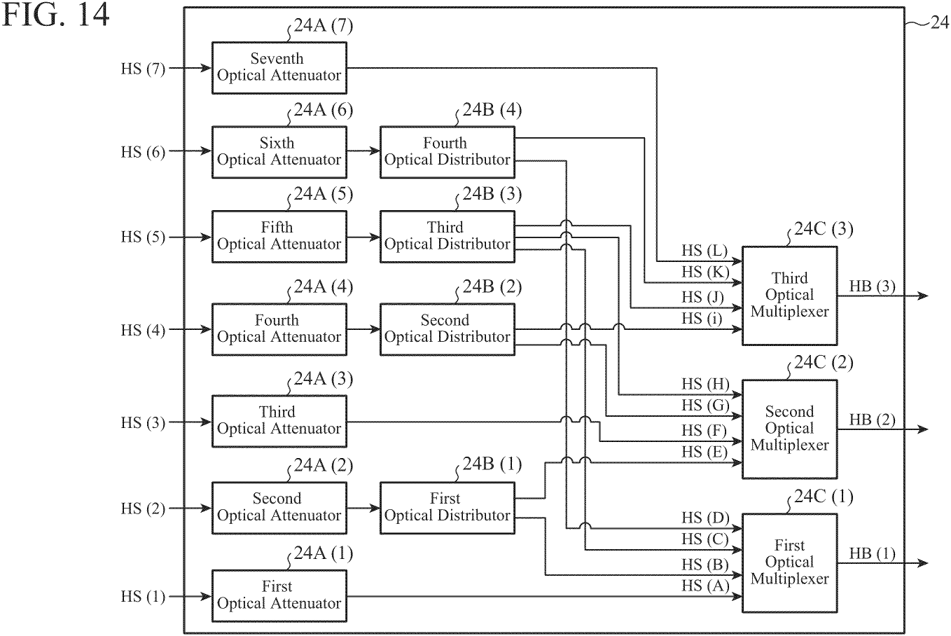

FIG. 14 illustrates a configuration of the gray-code optical multiplexing and distribution circuit 24 of the second embodiment.

As illustrated in FIG. 14, the gray-code optical multiplexing and distribution circuit 24 includes first to seventh optical attenuators 24A(1) to 24A(7), first to fourth optical distributors 24B(1) to 24B(4), and first to third optical multiplexers 24C(1) to 24C(3).

The first to seventh optical attenuators 24A(1) to 24A(7) attenuate the light intensities of the light components HS(1) to HS(7) output from the void grid frequency separator 23, similarly to the first to seventh optical attenuators 14A(1) to 14A(7) of the first embodiment.

The first to fourth optical distributors 24B(1) to 24B(4) are different from the first to fourth optical distributor 14B(1) to 14B(4) of the first embodiment, and as an example, distribute the light components HS(2), HS(4), HS(5), and HS(6) among the attenuated light components HS(1) to HS(7) output from the first to seventh optical attenuators 24A(1) to 24A(7).

The light components HS(2), HS(4), HS(5), and HS(6) described above are distributed and supplied, and the light components HS(1), HS(3), and HS(7) which are the other light components are supplied without being distributed. Accordingly, as illustrated in FIG. 14, the light components HS(A) to HS(D) are input to the first optical multiplexer 24C(1), the light components HS(E) to HS(H) are input to the second optical multiplexer 24C(2), and the light components HS(i) to HS(L) are input to the third optical multiplexer 24C(3).

The first optical multiplexer 24C(1) multiplexes the light components HS(A) to HS(D) to generate the first optical bit HB(1). The second optical multiplexer 24C(2) multiplexes the light components HS(E) to HS(H) to generate the second optical bit HB(2). The third optical multiplexer 24C(3) multiplexes the light components HS(i) to HS(L) to generate the third optical bit HB(3).

The gray-code optical multiplexing and distribution circuit 24 may be integrated using a planar lightwave circuit or silicon, or may not be integrated, that is, may be a barrack. It may be configured using a WDM coupler or a wavelength selection switch.

### Configuration of Decode Processor 28

The decode processor 28 includes, for example, a field programmable gate array (FPGA), a microcomputer, and a central processing unit (CPU). The decode processor 28 may sequentially process the decoding described above, or may collectively process the decoding after storing in a storage medium (Not shown.) such as a memory.

### Operation of Second Embodiment

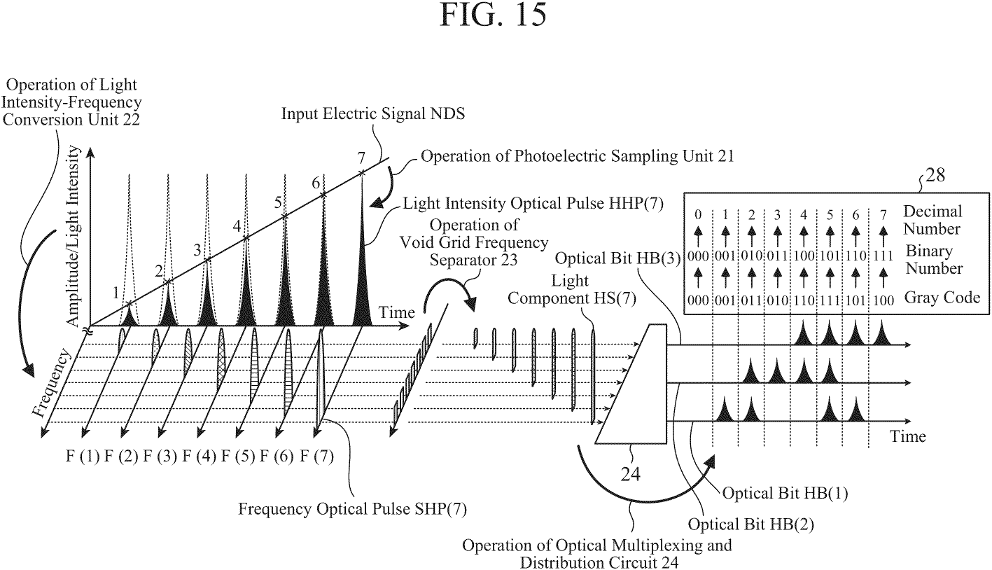

FIG. 15 illustrates an operation of the optical A/D conversion system 20 of the second embodiment.

The operation of the optical A/D conversion system 20 of the second embodiment will be described with reference to FIG. 15.

The operation from the photoelectric sampling unit 21 to the void grid frequency separator 23 of the second embodiment is similar to the operation from the photoelectric sampling unit 11 to the void grid frequency separator 13 of the first embodiment.

The operations of the first to third photoelectric converters 25(1) to 25(3) and the first to third electric A/D converters 26(1) to 26(3) of the second embodiment are similar to the operations of the first to third photoelectric converters 15(1) to 15(3) and the first to third electric A/D converters 16(1) to 16(3) of the first embodiment.

As an example, the gray-code optical multiplexing and distribution circuit 24 has input/output characteristics satisfying the following equation (2).

$$\left(\begin{matrix}{E}_{P D 1} \\ {E}_{P D 2} \\ {E}_{P D 3}\end{matrix}\right) = \left(\begin{matrix}1 & 1 & 0 & 0 & 1 & 1 & 0 \\ 0 & 1 & 1 & 1 & 1 & 0 & 0 \\ 0 & 0 & 0 & 1 & 1 & 1 & 1\end{matrix}\right) \left(\begin{matrix}\sqrt{1 / 1} & & 0 \\ & ⋱ & \\ 0 & & \sqrt{1 / 7}\end{matrix}\right) \left(\begin{matrix}{E}_{D W D M 1} \\ {E}_{D W D M 2} \\ {E}_{D W D M 3} \\ {E}_{D W D M 4} \\ {E}_{D W D M 5} \\ {E}_{D W D M 6} \\ {E}_{D W D M 7}\end{matrix}\right) \qquad \text{(2)}$$

As in the equation (1) of the first embodiment, assuming that s is an integer of 1 to 7 and t is an integer of 1 to 3, E_DWDMs is the optical field of the s-th light component HS(s) and E_PDt is the optical field of the t-th optical bit HB(t).

Here, similarly to the first embodiment, it is assumed that the light intensity optical pulses HHP(1) to HHP(7) input to the light intensity-frequency conversion unit 22 and the frequency optical pulses SHP(1) to SHP(7) output from the light intensity-frequency conversion unit 12 have a proportional relationship. Under the above assumption, since the light components HS(1) to HS(7) have equal electric fields and equal amplitudes, the rising edges of the optical bits HB(1) to HB(3) which are gray codes are synchronized with each other.

In contrast to the above, in a case where the light intensity optical pulses HHP(1) to HHP(7) and the frequency optical pulses SHP(1) to SHP(7) are not in a proportional relationship, or in a case where the spectra of the frequency optical pulses SHP(1) to SHP(7) are spread, the above synchronization is ensured by adjusting the loss value represented by the square root in the above equation (2) depending on the degree not in the proportional relationship or the degree of spread of the spectra, as described in the equation (1) of the first embodiment.

As illustrated from the operation of the decode processor 28 in FIG. 15, for example, the gray-code optical multiplexing and distribution circuit 24 converts the light component HS(1) of the center frequency F(1) corresponding to the input electric signal NDS having an amplitude value of 1 into the third optical bit HB(3) which is 0, the second optical bit HB(2) which is 0, and the first optical bit HB(1) which is 1. Accordingly, the optical bits HB(3) to HB(1) indicate “001” as a whole.

The gray-code optical multiplexing and distribution circuit 24 also converts, for example, the light component HS(2) of the center frequency F(2) corresponding to the input electric signal NDS having an amplitude value of 2 into the third optical bit HB(3) which is 0, the second optical bit HB(2) which is 1, and the first optical bit HB(1) which is 1. Accordingly, the optical bits HB(3) to HB(1) indicate “011” as a whole.

The gray-code optical multiplexing and distribution circuit 24 further converts, for example, the light component HS(3) of the center frequency F(3) corresponding to the input electric signal NDS having an amplitude value of 3 into the third optical bit HB(3) which is 0, the second optical bit HB(2) which is 1, and the first optical bit HB(1) which is 0. Accordingly, the optical bits HB(3) to HB(1) indicate “010” as a whole.

According to the above conversion, for example, “001” of the optical bits HB(3) to HB(1) indicating the amplitude value 1 of the input electric signal NDS is different from “011” of the optical bits HB(3) to HB(1) indicating the amplitude value 2 adjacent to the amplitude value 1 only by one bit, that is, only the second optical bit HB(2) is different.

Similarly, “011” of the optical bits HB(3) to HB(1) indicating the amplitude value 2 is different from “010” of the optical bits HB(3) to HB(1) indicating the amplitude value 3 adjacent to the amplitude value 2 only by one bit, that is, only the optical bit HB(1) is different.

Similarly to the first embodiment, the optical bits HB(1) to HB(3) pass through the first to third photoelectric converters 25(1) to 25(3) and the first to third electric A/D converters 26(1) to 26(3), and are quantized into output electric signals SDS(1) to SDS(3).

The decode processor 28 generates and outputs the final output electric signal SSDS by decoding the output electric signals SDS(1) to SDS(3) into a binary number or a decimal number.

### Effects of Second Embodiment

As described above, in the optical A/D conversion system 20 according to the second embodiment, in addition to the void grid frequency separator 23 performing the same separation as the void grid frequency separator 13 according to the first embodiment, the gray-code optical multiplexing and distribution circuit 24 performs conversion into gray codes. As a result, a situation is avoided in which a change of two bits occurs between the amplitude values adjacent to each other in the case of conversion into the normal code, for example, between the normal code “001” corresponding to the amplitude value 1 and the normal code “010” corresponding to the amplitude value 2, regarding the former amplitude value 1 and the latter amplitude value 2 adjacent to the amplitude value 1. As a result, the quantization error can be further reduced.

### Second Embodiment and Comparative Example

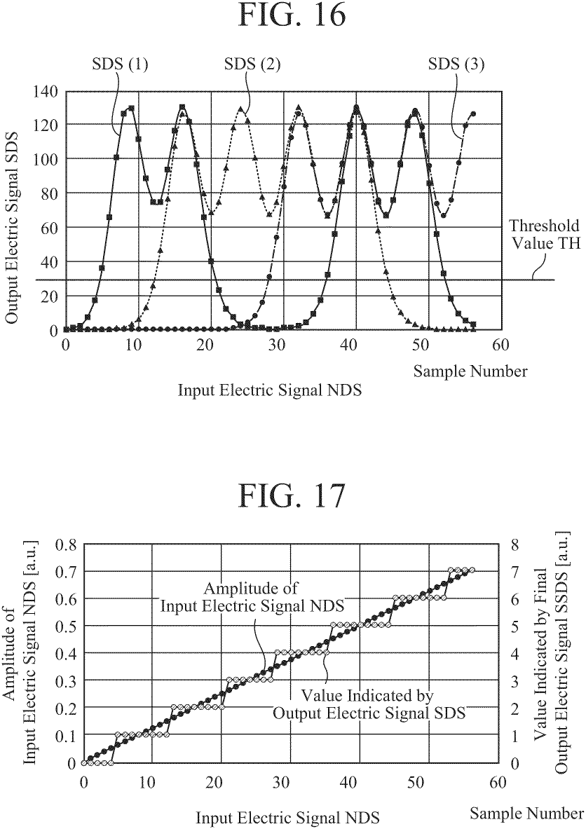

FIG. 16 shows the output electric signals SDS(1) to SDS(3) of the second embodiment.

In FIG. 16, as in FIG. 7 of the first embodiment, the horizontal axis represents the sample number of the input electric signal NDS. Specifically, the horizontal axis indicates 57 sample numbers of the input electric signal NDS in which the amplitude of the input electric signal NDS is linearly swept in increments of 0.1 from 0 to 7. The vertical axis represents the sizes of the output electric signals SDS(1) to SDS(3) quantized in 8 bits (255 ways).

Similarly to the first embodiment, when the output electric signals SDS(1) to SDS(3) are larger than the threshold value TH, those are determined to be 1, and on the other hand, when the output electric signals SDS(1) to SDS(3) are smaller than the threshold value TH, those are determined to be 0.

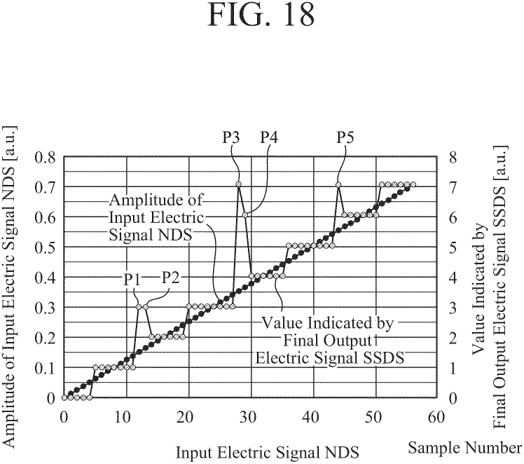

FIG. 17 illustrates a relationship between the amplitude of the input electric signal NDS and the value indicated by the final output electric signal SSDS according to the second embodiment.

The optical A/D conversion system 20 of the second embodiment converts the input electric signal NDS that is an analog value into the output electric signals SDS(1) to SDS(3) that are digital values without errors, similarly to the operation of the optical A/D conversion system 10 of the first embodiment (FIG. 8 illustrates the same.).

FIG. 18 illustrates a relationship between the amplitude of the input electric signal NDS and the value indicated by the final output electric signal SSDS according to a comparative example.

Unlike the second embodiment, the comparative example does not use conversion into a gray code. As a result, in the comparative example, as described above, two bits are different between the normal code “001” representing the amplitude value 1 of the input electric signal NDS and the normal code “010” representing the amplitude value 2. In the comparative example, due to the difference in the two bits, an error occurs in quantization at each of points P1 to P5, for example, as illustrated in FIG. 18.

### Other Embodiments: Optical Signal Processing System

Instead of the optical A/D conversion system 10 and the optical A/D conversion system 20 of the first embodiment having the above-described configuration and functions, for example, an optical signal processing system may have the above-described configuration and functions.

In the optical signal processing system, the light intensity optical pulses HHP(1) to HHP(7) and the optical bits HB(1) to HB(7), which are input and output of the optical quantization circuit 17 of the first embodiment or the optical quantization circuit 27 of the second embodiment, may be connected to a circuit other than the optical quantization circuit 17 of the first embodiment and the optical quantization circuit 27 of the second embodiment, for example, a circuit having at least one of a sampling function, an arithmetic function, and a storage function.

The optical signal processing system may further be integrated using at least one of a planar lightwave circuit and silicon.

Note that it is possible to combine the above-described embodiments and to modify or omit the components in each embodiment.

### INDUSTRIAL APPLICABILITY

The frequency separator according to the present disclosure can be used, for example, to suppress occurrence of an error in quantization.

### REFERENCE SIGNS LIST

10: optical A/D conversion system, 11: photoelectric sampling unit, 12: frequency conversion unit, 13: void grid frequency separator, 14: optical multiplexing and distribution circuit, first to third photoelectric converters: 15(1) to 15(3), first to third electric A/D converters: 16(1) to 16(3), 17: optical quantization circuit, 20: optical A/D conversion system, 21: photoelectric sampling unit, 22: frequency conversion unit, 23: void grid frequency separator, 24: gray-code optical multiplexing and distribution circuit, first to third photoelectric converters: 25(1) to 25(3), 26: first to third electric A/D converters 26(1) to 26(3), 27: quantization circuit, 28: decode processor, GR: grid, NDS: input electric signal, CDS: intermediate electric signal, SDS: output electric signal, SSDS: final output electric signal, HHP: light intensity optical pulse, SHP: frequency optical pulse, HS: light component, HB: optical bit, F: center frequency, ΔF: frequency band

1. A frequency separator comprising:
a plurality of filters to separate light having a plurality of first optical pulses, each of the first optical pulses having one of a plurality of frequencies, into a plurality of light components, each of the light components being to have one of a plurality of frequency bands corresponding to the plurality of frequencies, and to output the light components,
wherein among the plurality of filters, a center frequency of a first frequency band of a first filter and a center frequency of a second frequency band, adjacent to the first frequency band, of a second filter are separated beyond a bandwidth of each of the first and second frequency bands.

2. An optical quantization circuit comprising:
a first converter to convert a plurality of second optical pulses, each of the second optical pulses having one of a plurality of light intensities, into the plurality of first optical pulses, each of the first optical pulses having the one of the plurality of frequencies corresponding to the plurality of light intensities;
the frequency separator according to claim 1 to separate the plurality of first optical pulses obtained by conversion by the first converter into the plurality of light components; and
a second converter to convert the plurality of light components separated by the frequency separator into a plurality of optical bits representing a second value corresponding to a first value represented by presence or absence of the plurality of light components.

3. The optical quantization circuit according to claim 2, wherein the second converter converts the light component having the larger center frequency corresponding to the larger light intensity into the plurality of optical bits representing the larger second value.

4. The optical quantization circuit according to claim 2, wherein the second converter performs conversion from the plurality of light components into the plurality of optical bits in such a manner that one plurality of optical bits representing one second value corresponding to one first value represented by presence of one light component among the plurality of light components are different from another plurality of optical bits representing another second value corresponding to another first value represented by presence of another light component among the plurality of light components by only one bit.

5. The optical quantization circuit according to claim 4, wherein the second converter performs conversion from the plurality of light components into the plurality of optical bits using an expression having predetermined input/output characteristics in which the plurality of light components are input and the plurality of optical bits are output.

6. An optical A/D conversion system comprising:
the optical quantization circuit according to claim 2; and
a generator to generate the plurality of second optical pulses having the plurality of light intensities by performing modulation corresponding to an amplitude of an input electric signal.

7. The optical A/D conversion system according to claim 6, further comprising:
at least one photoelectric converter to convert each of the plurality of optical bits into an intermediate electric signal that is an analog value; and
at least one A/D converter to convert the intermediate electric signal into an output electric signal that is a first digital value.

8. The optical A/D conversion system according to claim 7, further comprising a decode processor to convert the output electric signal into a final output electric signal that is a second digital value.

9. An optical signal processing system comprising:
a circuit to receive the second optical pulses according to claim 2 and output the plurality of optical bits according to claim 2, the circuit having at least one of a sampling function, an arithmetic function, and a storage function.

10. The frequency separator according to claim 1, integrated using at least one of a planar lightwave circuit and silicon.

11. The optical quantization circuit according to claim 2, integrated using at least one of a planar lightwave circuit and silicon.

12. The optical A/D conversion system according to claim 6, integrated using at least one of a planar lightwave circuit and silicon.

13. The optical signal processing system according to claim 9, integrated using at least one of a planar lightwave circuit and silicon.
